(19) United States
(12) Patent Application Publication
(10) Pub. No.: US 2024/0405352 A1
(43) Pub. Date: Dec. 5, 2024

(54) SECONDARY BATTERY

(71) Applicant: MURATA MANUFACTURING CO., LTD., Kyoto (JP)

(72) Inventors: Kunio SODEYAMA, Kyoto (JP); Hemant PATNE, Kyoto (JP); Masafumi UMEKAWA, Kyoto (JP)

(21) Appl. No.: 18/796,805

(22) Filed: Aug. 7, 2024

Related U.S. Application Data
(63) Continuation of application No. PCT/JP2023/005244, filed on Feb. 15, 2023.

(30) Foreign Application Priority Data
Mar. 2, 2022 (JP) 2022-031633

(51) Int. Cl. H01M 50/342; H01M 10/48; H01M 50/152; H01M 50/531; H01M 50/586

(52) U.S. Cl. CPC H01M 50/3425; H01M 10/486; H01M 50/152; H01M 50/531; H01M 50/586

(57) ABSTRACT

The secondary battery includes a battery device, a container member, and a safety valve mechanism. The safety valve mechanism includes a valve member, an insulating holder, and an electrically conductive member. The valve member has an electrically conductive property. The valve member includes a valve part and an annular protruding part. The valve part is electrically coupled to a first electrode and cleavable. The annular protruding part surrounds the valve part along a horizontal plane. The horizontal plane is orthogonal to a height direction. The insulating holder surrounds the annular protruding part along the horizontal plane. The electrically conductive member includes a hook member including a hook. The hook is opposed to the annular protruding part with the insulating holder interposed between the hook and the annular protruding part. The electrically conductive member occupies an entire region that overlaps the insulating holder in the height direction.

### CROSS-REFERENCE TO RELATED APPLICATIONS

The present application is a continuation of International Application No. PCT/JP2023/005244, filed on Feb. 15, 2023, which claims priority from Japanese Patent Application No. 2022-031633, filed on Mar. 2, 2022, the entire contents of each of which are hereby incorporated by reference.

### BACKGROUND

The present technology relates to a secondary battery including a safety valve mechanism.

Various kinds of electronic equipment, including mobile phones, have been widely used. Such widespread use has invoked a need for a smaller size, a lighter weight, and a longer life of the electronic equipment. To address the need, a secondary battery that is smaller in size and lighter in weight has been developed as a power source.

A secondary battery is disclosed including a positive electrode, a negative electrode, and an electrolytic solution. In order to suppress occurrence of a malfunction due to a gas when the gas is generated due to, for example, a decomposition reaction of the electrolytic solution, the secondary battery includes a safety valve mechanism configured to release the gas to an outside on an as-needed basis.

### SUMMARY

A secondary battery according to an embodiment of the present technology includes a battery device, a container member, and a safety valve mechanism. The battery device includes a first electrode, a second electrode, and an electrolytic solution. The container member contains the battery device.

The safety valve mechanism is attached to an end part of the container member in a height direction of the container member. The safety valve mechanism includes a valve member, an insulating holder, and an electrically conductive member. The valve member has an electrically conductive property. The valve member includes a valve part and an annular protruding part. The valve part is electrically coupled to the first electrode and cleavable.

The annular protruding part surrounds the valve part along a horizontal plane. The horizontal plane is orthogonal to the height direction. The insulating holder surrounds the annular protruding part along the horizontal plane. The electrically conductive member includes a hook member including a hook.

The hook is opposed to the annular protruding part with the insulating holder interposed between the hook and the annular protruding part. The electrically conductive member occupies an entire region that overlaps the insulating holder in the height direction.

### BRIEF DESCRIPTION OF THE FIGURES

The accompanying drawings are included to provide a further understanding of the present technology and are incorporated in and constitute a part of this specification. The drawings illustrate example embodiments and, together with the specification, serve to explain the principles of the present technology.

FIG. 1 is a sectional diagram illustrating an overall configuration example of a secondary battery according to an embodiment of the present technology.

FIG. 2 is an enlarged sectional diagram illustrating a configuration example of an upper part of the secondary battery illustrated in FIG. 1.

FIG. 3 is an enlarged sectional diagram illustrating a configuration example of a safety valve mechanism of the secondary battery illustrated in FIG. 1.

FIG. 4 is an exploded perspective view of the safety valve mechanism illustrated in FIG. 3.

FIG. 5 is a schematic plan view of the safety valve mechanism illustrated in FIG. 3.

FIG. 6A is a schematic plan view of a body of a stripper disk illustrated in FIG. 3.

FIG. 6B is a schematic plan view of a hook member of the stripper disk illustrated in FIG. 3.

FIG. 7 is an enlarged sectional diagram illustrating a portion of a configuration of a battery device illustrated in FIG. 1.

FIG. 8 is a sectional diagram for describing an operation of the secondary battery.

FIG. 9 is a block diagram illustrating a configuration of an application example of the secondary battery, which is a battery pack.

FIG. 10A is an enlarged sectional diagram illustrating a configuration example of an upper part of a secondary battery according to a comparative example.

FIG. 10B is a schematic plan view of a stripper disk according to the comparative example illustrated in FIG. 10A.

FIG. 11 is an explanatory diagram schematically illustrating a method of measuring a safety valve activating pressure.

### DETAILED DESCRIPTION

Consideration has been given in various ways to improve performance of a secondary battery. There is, however, still room for improvement in terms of the performance of the secondary battery.

It is desirable to provide a secondary battery having superior performance.

The present technology is described below in further detail including with reference to the accompanying drawings. Note that the following description is directed to illustrative examples of the present technology and not to be construed as limiting to the present technology. Factors including, without limitation, numerical values, shapes, materials, components, positions of the components, and how the components are coupled to each other are illustrative only and not to be construed as limiting to the present technology. Further, elements in the following example embodiments which are not recited in a most-generic independent claim of the present technology are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present technology are unillustrated in the drawings.

A description is given first of a secondary battery according to an embodiment of the present technology.

Although a charge and discharge principle of the secondary battery to be described below is not particularly limited, the following description deals with a case where a battery capacity may be obtained through insertion and extraction of an electrode reactant.

The secondary battery may include a positive electrode, a negative electrode, and an electrolyte. In the secondary battery, a charge capacity of the negative electrode may be greater than a discharge capacity of the positive electrode. For example, an electrochemical capacity per unit area of the negative electrode may be greater than an electrochemical capacity per unit area of the positive electrode. One reason for this is to prevent precipitation of the electrode reactant on a surface of the negative electrode during charging.

Although not particularly limited in kind, the electrode reactant may be, for example, a light metal such as an alkali metal or an alkaline earth metal. Non-limiting examples of the alkali metal may include lithium, sodium, and potassium. Non-limiting examples of the alkaline earth metal may include beryllium, magnesium, and calcium.

Examples are given below of a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

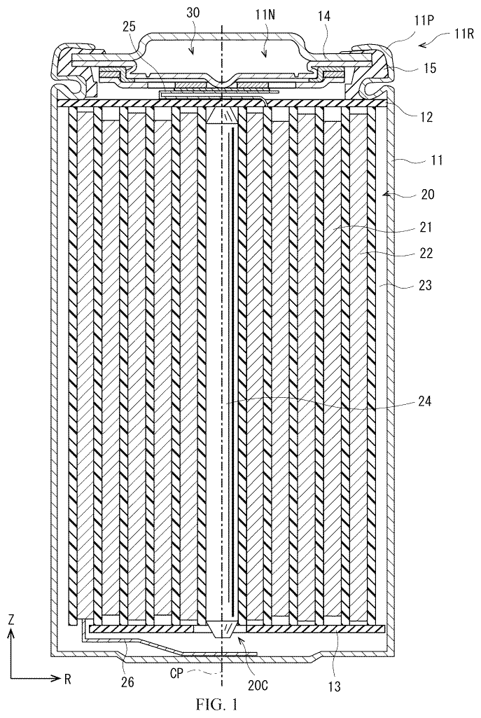

FIG. 1 illustrates a sectional configuration of the secondary battery. The secondary battery may be a secondary battery in which a battery device 20 is contained inside a battery can 11 having a cylindrical shape as illustrated in FIG. 1, that is, what is called a secondary battery of a cylindrical type. A reference sign CP denotes a central axis of the secondary battery.

Hereinafter, a direction in which the battery device 20 is placed into the battery can 11, for example, a height direction of the battery can 11 having the cylindrical shape, corresponds to a Z direction; and a radial direction of the battery can 11 having the cylindrical shape corresponds to an R direction.

For example, in the secondary battery illustrated in FIG. 1, a pair of insulating plates 12 and 13 and the battery device 20 may be contained inside the battery can 11 having the cylindrical shape, for example. A safety valve mechanism 30 may be attached to the battery can 11. The battery can 11 may be, for example, sealed by a battery cover 14. In an embodiment, the secondary battery may further include components including, without limitation, a thermosensitive resistive device and a reinforcing member inside the battery can 11. Non-limiting examples of the thermosensitive resistive device may include a positive temperature coefficient (PTC) device.

The battery can 11 and the battery cover 14 may correspond to a specific but non-limiting example of a “container member” in an embodiment of the present disclosure.

The battery can 11 may be a container having a hollow structure that extends in the Z direction, with one end part in the Z direction closed and another end part in the Z direction open. The one end part of the battery can 11 in the Z direction may be an open end part 11N. The battery can 11 may include, for example, any one or more of metal materials including, without limitation, iron, aluminum, and alloys thereof. In an embodiment, the battery can 11 may have a surface plated with, for example, any one or more of metal materials including, without limitation, nickel. The battery can 11 may correspond to a specific but non-limiting example of a “container” in an embodiment of the present disclosure.

The pair of insulating plates 12 and 13 may be disposed with the battery device 20 interposed therebetween in the Z direction and extend along a plane orthogonal to the Z direction.

The battery cover 14 and the safety valve mechanism 30 may be crimped at the open end part 11N of the battery can 11 with a gasket 15 interposed between the open end part 11N and both the battery cover 14 and the safety valve mechanism 30. The battery can 11 may thus be provided with a bent part 11P defining the open end part 11N.

The open end part 11N of the battery can 11 may be sealed by the battery cover 14 in a state where the battery device 20 and other components are contained inside the battery can 11. The battery can 11 may have a crimped structure 11R provided in the vicinity of the open end part 11N. The crimped structure 11R may be a structure in which the bent part 11P defining the open end part 11N and both the battery cover 14 and the safety valve mechanism 30 are crimped to each other with the gasket 15 interposed therebetween. The bent part 11P may be what is called a crimped part.

The battery cover 14 may be a cover that closes the open end part 11N of the battery can 11. In an embodiment, the battery cover 14 may include a material similar to the material included in the battery can 11. However, in an embodiment, the battery cover 14 may include a material different from the material included in the battery can 11.

In an embodiment, the battery cover 14 may include stainless steel. One reason for this is that this secures physical strength of the battery cover 14 and accordingly secures physical strength of the crimped structure 11R, suppressing detachment of the battery cover 14 and leakage of an electrolytic solution even if an internal pressure of the battery can 11 increases. Non-limiting examples of the stainless steel may include SUS304 and SUS430.

A middle part of the battery cover 14 may be bent to protrude in a direction away from the battery device 20, i.e., in a +Z direction. A portion other than the middle part, that is, a peripheral part, of the battery cover 14 may thus be adjacent to a safety cover 31 of the safety valve mechanism 30. The safety cover 31 will be described later.

The gasket 15 may be a sealing member that seals a gap between the bent part 11P and the battery cover 14. The gasket 15 may be interposed between the bent part 11P of the battery can 11 and the battery cover 14.

The gasket 15 may include any one or more of insulating materials. Non-limiting examples of the insulating materials may include a polymer material such as polybutylene terephthalate (PBT) or polypropylene (PP). In an embodiment, the gasket 15 may include polypropylene. One reason for this is that this helps to allow for sufficient sealing of the gap between the bent part 11P and the battery cover 14, with the battery can 11 and the battery cover 14 being electrically separated from each other.

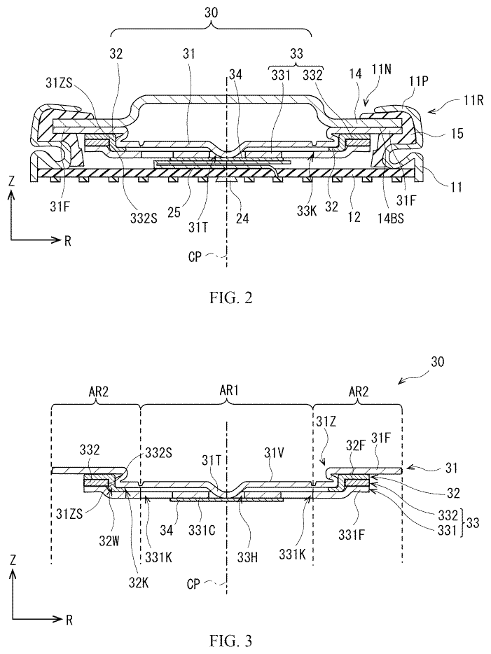

The safety valve mechanism 30 may be disposed on an inner side of the battery cover 14 in the Z direction. The safety valve mechanism 30 may be a mechanism that, when the internal pressure of the battery can 11 increases, releases the internal pressure by unsealing the battery can 11 on an as-needed basis. Non-limiting examples of a cause of the increase in the internal pressure of the battery can 11 may include a gas generated due to a decomposition reaction of the electrolytic solution during charging and discharging. A detailed configuration of the safety valve mechanism 30 will be described later with reference to FIGS. 2 to 6B to be described later.

The safety valve mechanism 30 may correspond to a specific but non-limiting example of a “safety valve mechanism” in an embodiment of the present disclosure.

The battery device 20 may be contained inside the battery can 11, and include a positive electrode 21, a negative electrode 22, and an electrolytic solution. The electrolytic solution may be a liquid electrolyte.

Here, the battery device 20 may be what is called a wound electrode body. For example, in the battery device 20, the positive electrode 21 and the negative electrode 22 may be stacked on each other with a separator 23 interposed therebetween, and the stack of the positive electrode 21, the negative electrode 22, and the separator 23 may be wound. The positive electrode 21, the negative electrode 22, and the separator 23 may each be impregnated with the electrolytic solution.

The battery device 20 may have, at the center thereof, a space resulting from winding the positive electrode 21, the negative electrode 22, and the separator 23, i.e., a center space 20C. A center pin 24 may be disposed in the center space 20C. However, in an embodiment, the center pin 24 may be omitted.

A positive electrode lead 25 may be coupled to the positive electrode 21. A negative electrode lead 26 may be coupled to the negative electrode 22. The positive electrode lead 25 may include any one or more of electrically conductive materials including, without limitation, a metal material. Non-limiting examples of the metal material included in the positive electrode lead 25 may include aluminum. The positive electrode lead 25 may be electrically coupled to the battery cover 14 via the safety valve mechanism 30. The negative electrode lead 26 may include any one or more of electrically conductive materials including, without limitation, a metal material. Non-limiting examples of the metal material included in the negative electrode lead 26 may include nickel. The negative electrode lead 26 may be electrically coupled to the battery can 11.

A detailed configuration of the battery device 20, i.e., a detailed configuration of each of the positive electrode 21, the negative electrode 22, the separator 23, and the electrolytic solution will be described later with reference to FIG. 7.

FIG. 2 illustrates a portion of a sectional configuration of the secondary battery illustrated in FIG. 1, and for example, illustrates the safety valve mechanism 30 and the vicinity thereof. FIG. 3 is an enlarged sectional diagram illustrating a configuration example of the safety valve mechanism 30.

The safety valve mechanism 30 may include a safety cover 31, a disk holder 32, a stripper disk 33, and a sub-disk 34 as illustrated in FIG. 2. The safety cover 31 and the stripper disk 33 may be fixed to each other with the disk holder 32 interposed therebetween. In addition, the safety cover 31 and the stripper disk 33 may be electrically insulated from each other by the disk holder 32, in a portion other than a coupling part. The coupling part may be provided in a middle region of each of the safety cover 31 and the stripper disk 33. The stripper disk 33 may be positioned on a side of the safety cover 31 opposed to the battery device 20. For example, the safety cover 31 may be provided between the stripper disk 33 and the battery cover 14. Further, the sub-disk 34 may be positioned closest to the battery device 20 in the safety valve mechanism 30. For example, the sub-disk 34 may be disposed between the stripper disk 33 and the battery device 20 and coupled to the positive electrode lead 25.

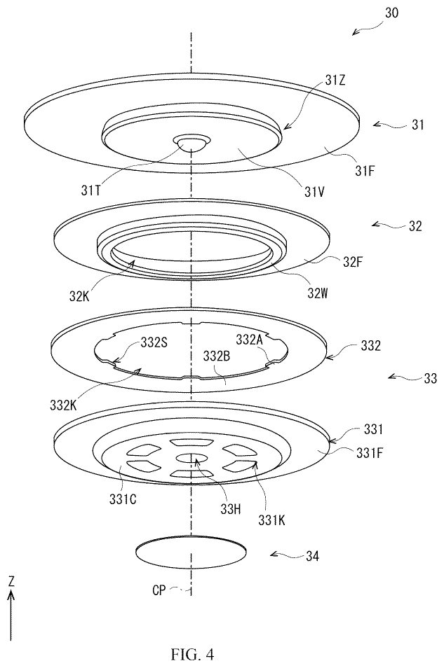

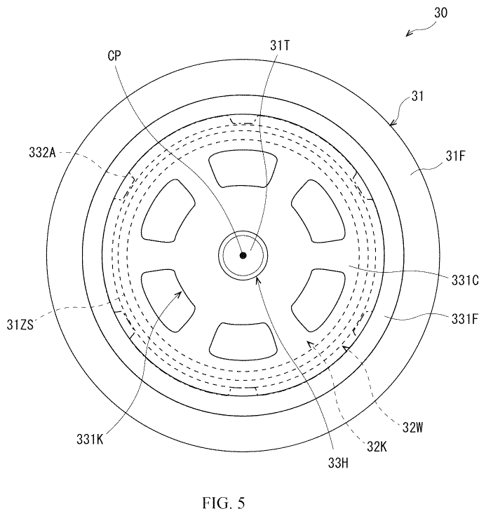

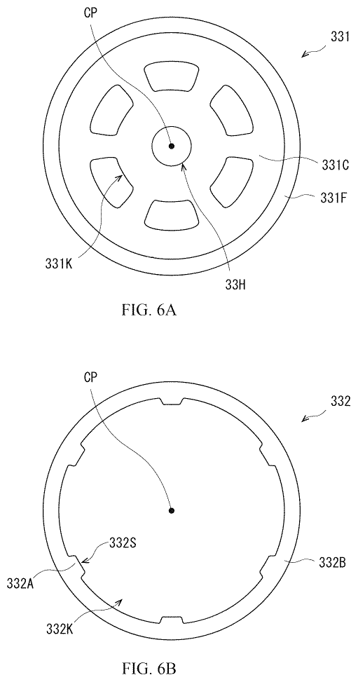

FIG. 4 is an exploded perspective view of the safety valve mechanism 30. FIG. 5 is a schematic plan view of the safety valve mechanism 30 illustrating a plan configuration example of the safety valve mechanism 30, along a horizontal plane orthogonal to the Z direction. FIG. 6A is a schematic diagram illustrating a plan configuration of a body 331 of the stripper disk 33 illustrated in, for example, FIG. 3. FIG. 6B is a schematic diagram illustrating a plan configuration of a hook member 332 of the stripper disk 33 illustrated in, for example, FIG. 3.

As illustrated in FIG. 2, the safety cover 31 may be an adjacent member adjacent to a bottom surface 14BS of the battery cover 14. The safety cover 31 may be cleavable in part, in response to an increase in the internal pressure of the battery can 11. The safety cover 31 may include a valve part 31V that is cleavable in response to an increase in the internal pressure of the battery can 11. The valve part 31V may be positioned in a middle region AR1 of the safety valve mechanism 30 as illustrated in FIG. 3. In an embodiment, when the safety cover 31 cleaves, the valve part 31V may cleave in part or the entire valve part 31V may break.

The safety cover 31 may further include an annular protruding part 31Z that surrounds the valve part 31V. The annular protruding part 31Z may be positioned in a peripheral region AR2 of the safety valve mechanism 30. The annular protruding part 31Z may include an end face 31ZS on an outer side thereof in the R direction that is the radial direction of the secondary battery. As will be described later, the end face 31ZS may be opposed to an end face 332S of the stripper disk 33 with an annular wall part 32W of the disk holder 32 interposed therebetween. A middle protruding part 31T may be provided at a position that overlaps a central position of the valve part 31V, i.e., a central axis CP. The middle protruding part 31T may protrude downward toward the battery device 20 from the valve part 31V. The middle protruding part 31T may be disposed in a through hole 33H, which will be described later, and in contact with an upper surface of the sub-disk 34.

The safety cover 31 may further include a flange part 31F in the peripheral region AR2. The flange part 31F may be a circular annular part that is positioned on an outer side of the annular protruding part 31Z in the R direction and extends along the horizontal plane orthogonal to the Z direction. The flange part 31F may overlap the bottom surface 14BS of the battery cover 14 in the Z direction.

The safety cover 31 may include any one or more of electrically conductive materials including, without limitation, a metal material. Non-limiting examples of the metal material may include aluminum and an aluminum alloy. A planar shape of the safety cover 31 is not particularly limited, and may be circular, for example. The “planar shape” may refer to a shape along the horizontal plane orthogonal to the Z direction. Hereinafter, the above-described definition of the planar shape may be similarly applicable.

The safety cover 31 may correspond to a specific but non-limiting example of a “valve member” in an embodiment of the present disclosure. The valve part 31V may correspond to a specific but non-limiting example of a “valve part” in an embodiment of the present disclosure. The annular protruding part 31Z may correspond to a specific but non-limiting example of an “annular protruding part” in an embodiment of the present disclosure.

The disk holder 32 may be a member that is interposed between the safety cover 31 and the stripper disk 33 to align the stripper disk 33 with respect to the safety cover 31 and so hold the stripper disk 33 as to fix the stripper disk 33 to the safety cover 31. The disk holder 32 may include any one or more of insulating materials including, without limitation, a polymer material. Non-limiting examples of the polymer material may include polypropylene (PP) and polybutylene terephthalate (PBT).

A planar shape of the disk holder 32 is not particularly limited, and may be circular, for example. The disk holder 32 may have an opening 32K that extends through the disk holder 32 in the Z direction at a position occupying the middle region AR1. The opening 32K may be a vent adapted to release the gas generated inside the battery can 11 to an outside. A planar shape of the opening 32K is not particularly limited, and may be circular, for example. The disk holder 32 may include the annular wall part 32W in the peripheral region AR2. The annular wall part 32W may be provided to surround the annular protruding part 31Z along the horizontal plane orthogonal to the Z direction.

As illustrated in FIGS. 3 and 4, the disk holder 32 may further include a flange part 32F. The flange part 32F may be a circular annular part that extends along the horizontal plane orthogonal to the Z direction. The flange part 32F may be sandwiched between the flange part 31F of the safety cover 31 and a flange part 331F of the stripper disk 33 in the Z direction.

The disk holder 32 may correspond to a specific but non-limiting example of an “insulating holder” in an embodiment of the present disclosure.

The stripper disk 33 may be a member that releases the gas generated inside the battery can 11. The stripper disk 33 may be configured to be electrically continuous with the valve part 31V of the safety cover 31 via the sub-disk 34. The safety cover 31 may be configured to be separated from the sub-disk 34 when the internal pressure of the secondary battery increases. The valve part 31V of the safety cover 31 being separated from the sub-disk 34 may cut off electrical continuity between the safety cover 31 and both the stripper disk 33 and the sub-disk 34, which may block a current inside the secondary battery. The stripper disk 33 may include any one or more of electrically conductive materials including, without limitation, a metal material. Non-limiting examples of the metal material may include aluminum and an aluminum alloy. The stripper disk 33 may correspond to a specific but non-limiting example of an “electrically conductive member” in an embodiment of the present disclosure.

The stripper disk 33 may include the body 331 and the hook member 332. The hook member 332 may be provided between the body 331 and the disk holder 32. The body 331 and the hook member 332 may be joined to each other by any of various methods including, without limitation, laser welding, resistance welding, and ultrasonic welding. The stripper disk 33 may be separate from the flange part 31F of the safety cover 31, and the flange part 32F of the disk holder 32 may be interposed in a gap between the stripper disk 33 and the flange part 31F.

A planar shape of the body 331 is not particularly limited, and may be circular, for example. The body 331 may include a middle part 331C having a circular plate shape and the flange part 331F having an annular shape. The middle part 331C having the circular plate shape may occupy the middle region AR1. The flange part 331F having the annular shape may be provided in the peripheral region AR2 to surround the middle part 331C along the horizontal plane. The middle part 331C may have the through hole 33H at a central position thereof. The through hole 33H may extend through the middle part 331C in the Z direction. The through hole 33H may allow the middle protruding part 31T to be disposed therein. The middle part 331C may further have an opening 331K around the through hole 33H. The opening 331K may extend through the middle part 331C in the Z direction. The opening 331K may be provided at a position that overlaps the valve part 31V in the Z direction. Similarly to the opening 32K, the opening 331K may be a vent adapted to release the gas generated inside the battery can 11 to the outside. Accordingly, as illustrated in FIG. 3 for example, the opening 331K may communicate with the opening 32K without being blocked by the disk holder 32. For example, the body 331 of the stripper disk 33 is provided to occupy the entire region that overlaps the disk holder 32 in the Z direction. With such a configuration, even when the disk holder 32 is softened by heating, it is possible to keep the disk holder 32 held at a predetermined position. In an embodiment, multiple openings 331K may be provided. One reason for this is that providing the multiple openings 331K helps to rapidly release the gas generated inside the battery to the outside, and to achieve a high level of safety. In an embodiment, the number of the openings 331K is not particularly limited, and may be more than or equal to 6 and less than or equal to 8. One reason for this is that setting the number of the openings 331K to be more than or equal to 6 helps to more efficiently discharge the gas generated inside the battery can 11 to the outside, and to achieve a higher level of safety. Another reason for this is that setting the number of the openings 331K to be less than or equal to 8 helps to achieve sufficient mechanical strength, and to further reduce variations in the safety valve activating pressure.

In an embodiment, in the safety valve mechanism 30, a ratio of a total opening area to a cleavage opening area may be more than or equal to 40% and less than or equal to 80%. Here, the cleavage opening area may be an area occupied by the valve part 31V along the horizontal plane orthogonal to the Z direction. The total opening area may be the sum of areas occupied by the one or more openings 331K in the stripper disk 33 along the horizontal plane orthogonal to the Z direction. One reason for setting the ratio of the total opening area to the cleavage opening area as above is that setting the ratio of the total opening area to the cleavage opening area to be more than or equal to 40% helps to more efficiently discharge the gas generated inside the battery can 11 to the outside, and to achieve a higher level of safety. Another reason for setting the ratio of the total opening area to the cleavage opening area as above is that setting the ratio of the total opening area to the cleavage opening area to be less than or equal to 80% helps to achieve sufficient mechanical strength, and to further reduce variations in the safety valve activating pressure.

A planar shape of the hook member 332 is not particularly limited, and may be circularly annular, for example. The hook member 332 may include a hook 332A and an annular support 332B. The annular support 332B may support the hook 332A. The annular support 332B may be joined to the flange part 331F with the annular support 332B overlapping the flange part 331F in the Z direction. In an embodiment, multiple hooks 332A may be disposed around the annular protruding part 31Z of the safety cover 31 along the horizontal plane. One reason for this is that providing the multiple hooks 332A along a direction that circulates around the central axis CP helps to reduce variations in the mechanical strength of the safety valve mechanism 30 depending on locations in the safety valve mechanism 30 in the horizontal plane. As illustrated in FIG. 6B, the hooks 332A may be provided on an inner side of the annular support 332B and protrude toward the central axis CP. The end face 332S at the distal end of each of the hooks 332A may be opposed to the end face 31ZS of the annular protruding part 31Z with the annular wall part 32W of the disk holder 32 interposed therebetween. For example, the hooks 332A and the annular protruding part 31Z sandwich the annular wall part 32W of the disk holder 32. The number of the hooks 332A is not particularly limited. In an embodiment, the number of the hooks 332 may be more than or equal to 6 and less than or equal to 9. One reason for this is that setting the number of the hooks 332A to be more than or equal to 6 helps to further reduce variations in the mechanical strength of the safety valve mechanism 30 depending on locations in the safety valve mechanism 30 in the horizontal plane. Another reason for this is that setting the number of the hooks 332A to be less than or equal to 9 helps to secure accuracy in machining the hooks 332A and ease of machining the hooks 332A.

The sub-disk 34 may be a member that is interposed between the safety cover 31 and the positive electrode lead 25 to electrically couple the middle protruding part 31T of the safety cover 31 to the positive electrode lead 25. The sub-disk 34 may include any one or more of electrically conductive materials including, without limitation, a metal material. Non-limiting examples of the metal material may include aluminum and an aluminum alloy. A planar shape of the sub-disk 34 is not particularly limited, and may be circular, for example.

The sub-disk 34 may correspond to a specific but non-limiting example of an “auxiliary member” in an embodiment of the present disclosure.

FIG. 7 illustrates, in an enlarged manner, a portion of a sectional configuration of the battery device 20 illustrated in FIG. 1. The battery device 20 may include the positive electrode 21, the negative electrode 22, the separator 23, and the electrolytic solution, as described above.

The positive electrode 21 may include, as illustrated in FIG. 7, a positive electrode current collector 21A and a positive electrode active material layer 21B.

The positive electrode current collector 21A may have two opposed surfaces on each of which the positive electrode active material layer 21B is to be provided. The positive electrode current collector 21A may include an electrically conductive material such as a metal material. Non-limiting examples of the metal material may include aluminum.

In an example illustrated in FIG. 7, the positive electrode active material layer 21B may be provided on each of the two opposed surfaces of the positive electrode current collector 21A. The positive electrode active material layer 21B may include any one or more of positive electrode active materials into which lithium is insertable and from which lithium is extractable. Note that, in an embodiment, the positive electrode active material layer 21B may be provided only on one of the two opposed surfaces of the positive electrode current collector 21A, on a side on which the positive electrode 21 is opposed to the negative electrode 22. In an embodiment, the positive electrode active material layer 21B may further include materials including, without limitation, a positive electrode binder and a positive electrode conductor. A method of forming the positive electrode active material layer 21B is not particularly limited, and may be, for example, a method such as a coating method.

The positive electrode active material may include a lithium compound. The lithium compound may be a compound including lithium as a constituent element, and may be, for example, a compound including lithium and one or more transition metal elements as constituent elements. One reason for this is that a high energy density is obtainable. Note that, in an embodiment, the lithium compound may further include any one or more of other elements, i.e., elements other than lithium and the transition metal elements.

The lithium compound is not limited to a particular kind, and non-limiting examples thereof may include a lithium composite oxide having a layered rock-salt crystal structure, a lithium composite oxide having a spinel crystal structure, and a lithium phosphoric acid compound having an olivine crystal structure. Non-limiting examples of the lithium composite oxide having the layered rock-salt crystal structure may include LiNiO₂, LiNi_{0.8}Co_{0.15}Al_{0.05}, and LiCoO₂. Non-limiting examples of the lithium composite oxide having the spinel crystal structure may include LiMn₂O₄. Non-limiting examples of the lithium phosphoric acid compound having the olivine crystal structure may include LiFePO₄ and LiMnPO₄.

In an embodiment, the positive electrode active material may include the lithium phosphoric acid compound having the olivine crystal structure. One reason for this is that, because the crystal structure of the lithium phosphoric acid compound having the olivine crystal structure is thermally stable, the secondary battery is prevented from easily exhibiting thermal runaway due to a cause such as overcharging or an internal short circuit. Another reason is that, because the crystal structure of the lithium phosphoric acid compound having the olivine crystal structure is firm, the battery capacity is prevented from decreasing easily even if the secondary battery is charged and discharged repeatedly.

The positive electrode binder may include any one or more of materials including, without limitation, a synthetic rubber and a polymer compound. Non-limiting examples of the synthetic rubber may include a styrene-butadiene-based rubber. Non-limiting examples of the polymer compound may include polyvinylidene difluoride.

The positive electrode conductor may include any one or more of electrically conductive materials including, without limitation, a carbon material. Non-limiting examples of the carbon material may include graphite, carbon black, acetylene black, and Ketjen black. Note that, in an embodiment, the electrically conductive material may be a metal material or a polymer compound, for example.

The negative electrode 22 may include, as illustrated in FIG. 7, a negative electrode current collector 22A and a negative electrode active material layer 22B.

The negative electrode current collector 22A may have two opposed surfaces on each of which the negative electrode active material layer 22B is to be provided. The negative electrode current collector 22A may include an electrically conductive material such as a metal material. Non-limiting examples of the metal material may include copper.

Here, the negative electrode active material layer 22B may be provided on each of the two opposed surfaces of the negative electrode current collector 22A. The negative electrode active material layer 22B may include any one or more of negative electrode active materials into which lithium is insertable and from which lithium is extractable. Note that, in an embodiment, the negative electrode active material layer 22B may be provided only on one of the two opposed surfaces of the negative electrode current collector 22A, on a side on which the negative electrode 22 is opposed to the positive electrode 21. In an embodiment, the negative electrode active material layer 22B may further include materials including, without limitation, a negative electrode binder and a negative electrode conductor. Details of the negative electrode binder may be similar to those of the positive electrode binder. Details of the negative electrode conductor may be similar to those of the positive electrode conductor. A method of forming the negative electrode active material layer 22B is not particularly limited, and may include, for example, any one or more of methods including, without limitation, a coating method, a vapor-phase method, a liquid-phase method, a thermal spraying method, and a firing or sintering method.

The negative electrode active material may include a carbon material, a metal-based material, or both, for example. One reason for this is that a high energy density is obtainable. Non-limiting examples of the carbon material may include graphitizable carbon, non-graphitizable carbon, and graphite such as natural graphite or artificial graphite. The metal-based material may be a material that includes, as one or more constituent elements, any one or more elements among metal elements and metalloid elements that are each able to form an alloy with lithium. Non-limiting examples of such metal elements and metalloid elements may include silicon, tin, or both. Note that, in an embodiment, the metal-based material may be a simple substance, an alloy, a compound, a mixture of two or more thereof, or a material including two or more phases thereof. Non-limiting examples of the metal-based material may include TiSi₂ and SiOₓ (0<x<2 or 0.2<x<1.4).

The separator 23 may be an insulating porous film interposed between the positive electrode 21 and the negative electrode 22 as illustrated in FIG. 7. The separator 23 may allow lithium ions to pass therethrough while preventing a short circuit between the positive electrode 21 and the negative electrode 22. The separator 23 may include a polymer compound such as polyethylene.

The electrolytic solution may include a solvent and an electrolyte salt. The solvent may include any one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is what is called a non-aqueous electrolytic solution. However, in an embodiment, the solvent may be an aqueous solvent. The electrolyte salt may include any one or more of light metal salts including, without limitation, a lithium salt. A content of the electrolyte salt is not particularly limited. In an embodiment, the content of the electrolyte salt may be within a range from 0.3 mol/kg to 3 mol/kg both inclusive with respect to the solvent. One reason for this is that high ion conductivity is obtainable.

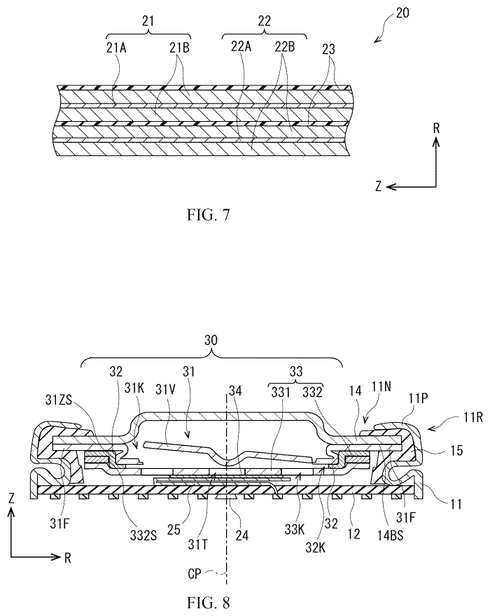

FIG. 8 is an explanatory diagram for describing an operation of the secondary battery of the example embodiment and for describing, for example, behavior of the secondary battery at a time when the internal pressure increases. FIG. 8 illustrates a sectional configuration corresponding to FIG. 2. In the following, an operation at the time of charging and discharging will be described, and thereafter, the operation at the time when the internal pressure increases will be described. In this case, reference is also made to FIG. 2 in addition to FIG. 8 where appropriate.

Upon charging, in the battery device 20, lithium may be extracted from the positive electrode 21, and the extracted lithium may be inserted into the negative electrode 22 via the electrolytic solution. Upon discharging, in the battery device 20, lithium may be extracted from the negative electrode 22, and the extracted lithium may be inserted into the positive electrode 21 via the electrolytic solution. Upon such charging and discharging, lithium may be inserted and extracted in an ionic state.

Upon charging and discharging of the secondary battery, when the internal pressure of the battery can 11 increases, the safety valve mechanism 30 may operate in order to prevent the secondary battery from, for example, rupturing or being damaged.

For example, upon a normal operation of the secondary battery, the valve part 31V of the safety cover 31 may have not yet cleaved, as illustrated in FIG. 2. Therefore, an opening 332K of the stripper disk 33 may be closed by the safety cover 31.

When a gas is generated inside the battery can 11 due to a side reaction such as a decomposition reaction of the electrolytic solution, the generated gas may be accumulated inside the battery can 11, and the internal pressure of the battery can 11 may increase. Here, when the internal pressure of the battery can 11 reaches a certain level or higher, the valve part 31V of the safety cover 31 may cleave in part, as illustrated in FIG. 8. This may provide an opening 31K in the safety cover 31, which may open a gas releasing path with the openings 332K, 32K, and 31K. As a result, the gas generated inside the battery can 11 may be released through the openings 332K, 32K, and 31K. In addition, the valve part 31V of the safety cover 31 may separate from the sub-disk 34. This may cut off the electrical continuity between both the sub-disk 34 and the stripper disk 33 and the safety cover 31, and block the current inside the secondary battery.

Note that depending on the level of the internal pressure of the secondary battery, the bent part 11P may be deformed, and the crimped structure 11R may therefore be broken. As a result, the battery cover 14 may be detached from the battery can 11, and the gas may thus be released to the outside of the secondary battery.

First, the positive electrode active material may be mixed with materials including, without limitation, the positive electrode binder and the positive electrode conductor on an as-needed basis to thereby obtain a positive electrode mixture. Thereafter, the positive electrode mixture may be dispersed in a solvent to thereby obtain a positive electrode mixture slurry in paste form. The solvent is not limited to a particular kind, and in an embodiment, the solvent may be an aqueous solvent. In an embodiment, the solvent may be a non-aqueous solvent such as an organic solvent. Thereafter, the positive electrode mixture slurry may be applied on the two opposed surfaces of the positive electrode current collector 21A to thereby form the positive electrode active material layers 21B. Thereafter, the positive electrode active material layers 21B may be compression-molded by means of, for example, a roll pressing machine. In this case, in an embodiment, the positive electrode active material layers 21B may be heated. In an embodiment, the positive electrode active material layers 21B may be compression-molded multiple times. In this manner, the positive electrode active material layers 21B may be formed on the respective two opposed surfaces of the positive electrode current collector 21A. As a result, the positive electrode 21 may be fabricated.

The negative electrode active material layers 22B may be formed on the respective two opposed surfaces of the negative electrode current collector 22A by a procedure similar to that of the positive electrode 21 described above. For example, the negative electrode active material may be mixed with materials including, without limitation, the negative electrode binder and the negative electrode conductor to thereby obtain a negative electrode mixture. Thereafter, the negative electrode mixture may be dispersed in a solvent to thereby obtain a negative electrode mixture slurry in paste form. Details of the solvent may be as described above. Thereafter, the negative electrode mixture slurry may be applied on the two opposed surfaces of the negative electrode current collector 22A to thereby form the negative electrode active material layers 22B. Thereafter, the negative electrode active material layers 22B may be compression-molded by means of, for example, a roll pressing machine. Details of compression molding may be as described above. In this manner, the negative electrode active material layers 22B may be formed on the respective two opposed surfaces of the negative electrode current collector 22A. As a result, the negative electrode 22 may be fabricated.

First, the positive electrode lead 25 may be coupled to the positive electrode current collector 21A of the positive electrode 21 by a method such as a welding method. In a similar manner, the negative electrode lead 26 may be coupled to the negative electrode current collector 22A of the negative electrode 22 by a method such as a welding method. Thereafter, the positive electrode 21 and the negative electrode 22 may be stacked on each other with the separator 23 interposed therebetween to form a stacked body, following which the obtained stacked body may be wound to thereby form a wound body having the center space 20C. The wound body may have a configuration similar to that of the battery device 20 except that the positive electrode 21, the negative electrode 22, and the separator 23 are each not impregnated with the electrolytic solution. Thereafter, the center pin 24 may be placed in the center space 20C of the wound body.

Thereafter, the battery can 11 may be prepared, following which the insulating plates 12 and 13 may be opposed to each other with the wound body interposed therebetween, and the wound body, together with the insulating plates 12 and 13, may be placed inside the battery can 11. In this case, the positive electrode lead 25 may be coupled to the safety valve mechanism 30 by a method such as a welding method, and the negative electrode lead 26 may be coupled to the battery can 11 by a method such as a welding method.

Thereafter, the electrolytic solution may be injected into the battery can 11 to thereby impregnate the wound body with the electrolytic solution. As a result, the positive electrode 21, the negative electrode 22, and the separator 23 may each be impregnated with the electrolytic solution, and the battery device 20 may be fabricated. Thereafter, the battery cover 14 and the safety valve mechanism 30 may be placed inside the battery can 11 together with the gasket 15. Note that the safety valve mechanism 30 may be fabricated by sequentially stacking the safety cover 31, the disk holder 32, the stripper disk 33, and the sub-disk 34 as illustrated in FIG. 4.

Thereafter, the open end part 11N and both the battery cover 14 and the safety valve mechanism 30 may be crimped to each other with the gasket 15 interposed therebetween at the open end part 11N of the battery can 11, as illustrated in FIG. 1. In such a manner, the bent part 11P may be formed, and the crimped structure 11R may therefore be formed. As a result, the battery can 11 may be closed by the battery cover 14, and the assembly of the secondary battery may be finished.

The assembled secondary battery may be charged and discharged. Various conditions including, for example, an environment temperature, the number of times of charging and discharging (the number of cycles), and charging and discharging conditions may be set as desired. A film may thereby be formed on a location such as a location on a surface of the negative electrode 22. This may bring the secondary battery into an electrochemically stable state. As a result, the secondary battery of the cylindrical type may be completed in which the battery device 20 and other components are sealed inside the battery can 11.

In the secondary battery according to the example embodiment, the safety valve mechanism 30 includes at least the safety cover 31, the disk holder 32, and the stripper disk 33. The disk holder 32 may be sandwiched between the safety cover 31 and the stripper disk 33. The stripper disk 33 occupies the entire region that overlaps the disk holder 32 in the Z direction. Accordingly, the secondary battery of the example embodiment makes it possible for the disk holder 32 to stay at the predetermined position without flowing out even when the disk holder 32 is softened due to generation of heat inside the battery can 11, because the disk holder 32 is sandwiched between the flange part 31F of the safety cover 31 and the stripper disk 33 in the Z direction. As a result, unintentional contact is avoided between the flange part 31F and the stripper disk 33, allowing the safety valve mechanism 30 to operate stably. This helps to achieve a high level of safety.

In an embodiment, the stripper disk 33 may have a configuration in which the hook member 332 including the hook 332A and the annular support 332B is joined to the body 331 that is separate from the hook member 332. For example, if a hook is formed on a portion of the stripper disk by press molding, a U-shaped through hole may be formed around the hook. In contrast, the safety valve mechanism 30 of the example embodiment may have a configuration in which two components, i.e., the hook member 332 including the hook 332A and the body 331, are integrated by joining. This allows the safety valve mechanism 30 not to have an unnecessary hook hole. This makes it possible for the stripper disk 33 of the safety valve mechanism 30 to effectively prevent the softened disk holder 32 from flowing out, and helps to improve the mechanical strength of the stripper disk 33 itself. In an embodiment, in the safety valve mechanism 30, the hook member 332 including the hook 332A and the body 331 may be joined by welding. This helps to further improve the mechanical strength of the safety valve mechanism 30 while making it easy to assemble the safety valve mechanism 30.

In an embodiment, the stripper disk 33 may have the one or more openings 331K at respective one or more positions overlapping the valve part 31V in the Z direction. This helps to rapidly release the gas generated inside the battery can 11 to the outside, and to achieve a high level of safety. In an embodiment, the number of the openings 331K may be set to be more than or equal to 6. This helps to more efficiently release the gas generated inside the battery can 11 to the outside, and to achieve a higher level of safety. In an embodiment, the number of the openings 331K may be set to be less than or equal to 8. This helps to achieve sufficient mechanical strength and to further reduce variations in the safety valve activating pressure.

In an embodiment, the ratio, i.e., an opening area ratio, of the total opening area to the cleavage opening area may be set to be more than or equal to 40%. This helps to more efficiently release the gas generated inside the battery can 11 to the outside, and to achieve a higher level of safety. In an embodiment, the opening area ratio may be set to be less than or equal to 80%. This helps to achieve sufficient mechanical strength and to further reduce variations in the safety valve activating pressure.

In an embodiment, the multiple hooks 332A may be disposed around the annular protruding part 31Z of the safety cover 31 along the horizontal plane orthogonal to the Z direction. This helps to reduce variations in the mechanical strength of the safety valve mechanism 30 depending on locations in the safety valve mechanism 30 in the horizontal plane. In an embodiment, the number of the hooks 332A may be set to be more than or equal to 6. This helps to further reduce variations in the mechanical strength of the safety valve mechanism 30 depending on locations in the safety valve mechanism 30 in the horizontal plane. In an embodiment, the number of the hooks 332A may be set to be less than or equal to 9. This helps to improve the accuracy in machining the hooks 332A and the ease of machining the hooks 332A.

In an embodiment, the safety valve mechanism 30 may further include the sub-disk 34 that has an electrically conductive property. The sub-disk 34 may be disposed between the positive electrode lead 25 and the valve part 31V of the safety cover 31. The valve part 31V may be electrically coupled to the positive electrode lead 25 via the sub-disk 34. This helps to stably and easily couple the positive electrode lead 25 to the sub-disk 34, and to stably obtain the electrically continuous state between the positive electrode lead 25 and the safety cover 31. This helps to achieve high reliability.

In an embodiment, the positive electrode 21 may include the lithium phosphoric acid compound having the olivine crystal structure. This helps to prevent the secondary battery from easily exhibiting the thermal runaway, and also to prevent the battery capacity from easily decreasing even if the secondary battery is repeatedly charged and discharged. This helps to achieve higher operation reliability. In an embodiment, the positive electrode 21 may include a nickel-cobalt composite oxide of a layered rock-salt crystal structure. This helps to obtain a battery superior in balance between a large output characteristic and an energy density.

In an embodiment, the secondary battery may include a lithium-ion secondary battery. This helps to obtain a sufficient battery capacity stably through insertion and extraction of lithium. This helps to achieve higher operation reliability.

The configuration of the secondary battery may be appropriately modifiable as described below according to an embodiment. In an embodiment, any two or more of the following series of modification examples may be combined with each other.

In the example embodiment described above, the separator 23 that is a porous film may be used. In an embodiment, the secondary battery may include a separator of a stacked type including a polymer compound layer, instead of the separator 23 that is the porous film.

For example, the separator of the stacked type may include a porous film having two opposed surfaces, and the polymer compound layer disposed on one of or each of the two opposed surfaces of the porous film. This improves adherence of the separator to each of the positive electrode 21 and the negative electrode 22, and therefore suppresses misalignment of the battery device 20, i.e., winding displacement of each of the positive electrode 21, the negative electrode 22, and the separator. Accordingly, swelling of the secondary battery is suppressed, even if, for example, the decomposition reaction of the electrolytic solution occurs. The polymer compound layer may include a polymer compound such as polyvinylidene difluoride. One reason for this is that the polymer compound such as polyvinylidene difluoride has superior physical strength and is electrochemically stable.

In an embodiment, the porous film, the polymer compound layer, or both may each include any one or more kinds of insulating particles. One reason for this is that the insulating particles dissipate heat upon heat generation by the secondary battery, thus improving safety or heat resistance of the secondary battery. Non-limiting examples of the insulating particles may include inorganic particles and resin particles. Non-limiting examples of the inorganic particles may include particles of: aluminum oxide, aluminum nitride, boehmite, silicon oxide, titanium oxide, magnesium oxide, and zirconium oxide. Non-limiting examples of the resin particles may include particles of acrylic resin and particles of styrene resin.

In a case of fabricating the separator of the stacked type, a precursor solution including, without limitation, the polymer compound and an organic solvent may be prepared, following which the precursor solution may be applied on one of or each of the two opposed surfaces of the porous film. In an embodiment, the insulating particles may be added to the precursor solution.

In the case where the separator of the stacked type is used also, lithium ions may be movable between the positive electrode 21 and the negative electrode 22, and similar effects may therefore be obtainable.

In the example embodiment described above, the electrolytic solution that is a liquid electrolyte may be used. In an embodiment, the secondary battery may include an electrolyte layer that is a gel electrolyte, instead of the electrolytic solution.

In the battery device 20 including the electrolyte layer, the positive electrode 21 and the negative electrode 22 may be stacked on each other with the separator 23 and the electrolyte layer interposed therebetween, and the stack of the positive electrode 21, the negative electrode 22, the separator 23, and the electrolyte layer may be wound. The electrolyte layer may be interposed between the positive electrode 21 and the separator 23, and between the negative electrode 22 and the separator 23.

For example, the electrolyte layer may include a polymer compound together with the electrolytic solution. The electrolytic solution may be held by the polymer compound in the electrolyte layer. One reason for this is that the leakage of the electrolytic solution is prevented. The configuration of the electrolytic solution may be as described above. The polymer compound may include, for example, polyvinylidene difluoride. In a case of forming the electrolyte layer, a precursor solution including, for example, the electrolytic solution, the polymer compound, and an organic solvent may be prepared, following which the precursor solution may be applied on one side or both sides of the positive electrode 21 and on one side or both sides of the negative electrode 22.

In a case where the electrolyte layer is used also, lithium ions may be movable between the positive electrode 21 and the negative electrode 22 via the electrolyte layer, and similar effects are therefore obtainable.

Next, a description is given of application examples of the above-described secondary battery according to an embodiment.

The applications of the secondary battery are not particularly limited. The secondary battery used as a power source may serve as a main power source or an auxiliary power source of, for example, electronic equipment and an electric vehicle. The main power source may be preferentially used regardless of the presence of any other power source. The auxiliary power source may be used in place of the main power source, or may be switched from the main power source.

Non-limiting examples of the applications of the secondary battery may include: electronic equipment; apparatuses for data storage; electric power tools; battery packs to be mounted on, for example, electronic equipment; medical electronic equipment; electric vehicles; electric power storage systems, and any other application to which the secondary battery is applicable. Non-limiting examples of the electronic equipment may include video cameras, digital still cameras, mobile phones, laptop personal computers, headphone stereos, portable radios, portable information terminals, and any other equipment to which the secondary battery is applicable. Non-limiting examples of the apparatuses for data storage may include backup power sources and memory cards. Non-limiting examples of the electric power tools may include electric drills, electric saws, and any other electric power tool to which the secondary battery is applicable. Non-limiting examples of the medical electronic equipment may include pacemakers, hearing aids, and any other medical electronic equipment to which the secondary battery is applicable. Non-limiting examples of the electric vehicles may include electric automobiles including hybrid automobiles, and any other vehicle to which the secondary battery is applicable. Non-limiting examples of the electric power storage systems may include battery systems for home use or industrial use in which electric power is accumulated for a situation such as emergency, and any other electric power storage system to which the secondary battery is applicable. In an embodiment, the above-described applications may each use one secondary battery, or may each use multiple secondary batteries.

In an embodiment, the battery packs may each include a single battery, or may each include an assembled battery. In an embodiment, the electric vehicle may be a vehicle that operates or travels using the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example, home appliances.

An application example of the secondary battery will now be described in further detail according to an embodiment. The configuration of the application example described below is merely an example, and is appropriately modifiable.

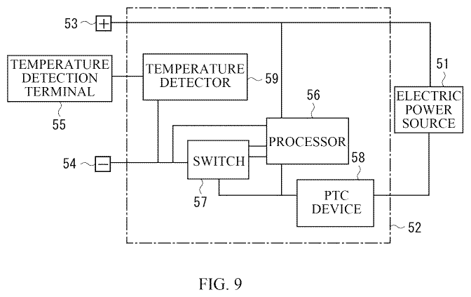

FIG. 9 illustrates a block configuration of a battery pack. The battery pack described here may be a battery pack, i.e., what is called a soft pack, including one secondary battery, and may be to be mounted on, for example, electronic equipment such as a smartphone.

As illustrated in FIG. 9, the battery pack may include an electric power source 51 and a circuit board 52. The circuit board 52 may be coupled to the electric power source 51, and may include a positive electrode terminal 53, a negative electrode terminal 54, and a temperature detection terminal 55.

The electric power source 51 may include one secondary battery. The secondary battery may have a positive electrode lead coupled to the positive electrode terminal 53 and a negative electrode lead coupled to the negative electrode terminal 54. The electric power source 51 may be couplable to external equipment via the positive electrode terminal 53 and the negative electrode terminal 54, and may thus be chargeable and dischargeable. The circuit board 52 may include a processor 56, a switch 57, a thermosensitive resistive device 58, e.g., the PTC device, and a temperature detector 59. However, in an embodiment, the PTC device 58 may be omitted.

The processor 56 may include, for example, a central processing unit (CPU) and a memory, and control an overall operation of the battery pack. The processor 56 may detect and control a use state of the electric power source 51 on an as-needed basis.

If a voltage of the electric power source 51, i.e., the secondary battery, reaches an overcharge detection voltage or an overdischarge detection voltage, the processor 56 may turn off the switch 57. This prevents a charging current from flowing into a current path of the electric power source 51. For example, the overcharge detection voltage may be 4.2 V±0.05 V, and the overdischarge detection voltage may be 2.4 V±0.1 V.

The switch 57 may include, for example, a charge control switch, a discharge control switch, a charging diode, and a discharging diode. The switch 57 may perform switching between coupling and decoupling between the electric power source 51 and the external equipment in accordance with an instruction from the processor 56. The switch 57 may include, for example, a metal-oxide-semiconductor field-effect transistor (MOSFET). The charging and discharging currents may be detected based on an ON-resistance of the switch 57.

The temperature detector 59 may include a temperature detection device such as a thermistor. The temperature detector 59 may measure a temperature of the electric power source 51 through the temperature detection terminal 55, and output a result of the temperature measurement to the processor 56. The result of the temperature measurement to be obtained by the temperature detector 59 may be used, for example, in a case where the processor 56 performs charge/discharge control upon abnormal heat generation or in a case where the processor 56 performs a correction process upon calculating a remaining capacity.

### EXAMPLES

A description is given of Examples of an embodiment of the present technology.

### Example 1

Secondary batteries were fabricated as follows, following which the secondary batteries were each evaluated for a battery characteristic.

### [Fabrication of Secondary Battery]

The lithium-ion secondary batteries of the cylindrical type illustrated in FIG. 1 (having a diameter, i.e., an outer diameter of 21 mm, and a length of 70 mm) were fabricated in accordance with the following procedure.

### [Fabrication of Positive Electrode]

First, 94 parts by mass of the positive electrode active material (LiNi_{0.8}Co_{0.15}Al_{0.05}), 3 parts by mass of the positive electrode binder (polyvinylidene difluoride), and 3 parts by mass of the positive electrode conductor (graphite) were mixed with each other to thereby obtain a positive electrode mixture. Thereafter, the positive electrode mixture was put into a solvent (N-methyl-2-pyrrolidone as the organic solvent), following which the organic solvent was stirred to thereby prepare a positive electrode mixture slurry in paste form. Thereafter, the positive electrode mixture slurry was applied on the two opposed surfaces of the positive electrode current collector 21A (a band-shaped aluminum foil having a thickness of 15 m) by means of a coating apparatus, following which the applied positive electrode mixture slurry was dried to thereby form the positive electrode active material layers 21B. Thereafter, the positive electrode active material layers 21B were compression-molded by means of a roll pressing machine.

### [Fabrication of Negative Electrode]

First, 95 parts by mass of the negative electrode active material (graphite), 3 parts by mass of the negative electrode binder (styrene-butadiene rubber (SBR)), and 2 parts by mass of the negative electrode conductor (carbon black) were mixed with each other to thereby obtain a negative electrode mixture. Thereafter, the negative electrode mixture was put into a solvent (water), following which the organic solvent was stirred to thereby prepare a negative electrode mixture slurry in paste form. Thereafter, the negative electrode mixture slurry was applied on the two opposed surfaces of the negative electrode current collector 22A (a band-shaped copper foil having a thickness of 15 m) by means of a coating apparatus, following which the applied negative electrode mixture slurry was dried to thereby form the negative electrode active material layers 22B. Thereafter, the negative electrode active material layers 22B were compression-molded by means of a roll pressing machine.

### [Preparation of Electrolytic Solution]

The electrolyte salt (LiPF₆) was added to the solvent (ethylene carbonate, ethyl methyl carbonate, and dimethyl carbonate), following which the solvent was stirred. In this case, a mixture ratio (a weight ratio) between ethylene carbonate, ethyl methyl carbonate, and dimethyl carbonate in the solvent was set to 20:20:60, and the content of the electrolyte salt was set to 1 mol/kg with respect to the solvent.

### [Assembly of Secondary Battery]

First, the positive electrode lead 25 including aluminum was welded to the positive electrode current collector 21A of the positive electrode 21, and the negative electrode lead 26 including nickel was welded to the negative electrode current collector 22A of the negative electrode 22. Thereafter, the positive electrode 21 and the negative electrode 22 were stacked on each other with the separator 23 (a porous polyethylene film having a thickness of 16 m) interposed therebetween, following which the stack of the positive electrode 21, the negative electrode 22, and the separator 23 was wound to thereby fabricate the wound body having the center space 20C. Thereafter, the center pin 24 was placed in the center space 20C of the wound body.

Thereafter, the safety valve mechanism 30 that included the safety cover 31 including aluminum, the disk holder 32 including polybutylene terephthalate (PBT), and the stripper disk 33 including aluminum was prepared. In this case, the opening area ratio was set to 39%, the number of the openings 331K was set to 6, and the number of the hooks 332A was set to 6. The opening area ratio was obtained by dividing the total opening area by the cleavage opening area.

Thereafter, the wound body was placed, together with the pair of insulating plates 12 and 13, inside the battery can 11. The battery can 11 included iron and was plated with nickel. The positive electrode lead 25 was welded to the stripper disk 33 of the safety valve mechanism 30, and the negative electrode lead 26 was welded to the battery can 11. Thereafter, the electrolytic solution was injected into the battery can 11 by a reduced-pressure method to thereby cause the wound body to be impregnated with the electrolytic solution.

Thereafter, asphalt was added to a solvent (ethylcyclohexane as an organic solvent), following which the solvent was stirred to thereby prepare a coating solution. Thereafter, the coating solution was applied to the gasket 15 including polypropylene.

Thereafter, the open end part 11N of the battery can 11 and both the battery cover 14 and the safety valve mechanism 30 were crimped to each other with the gasket 15 including polypropylene interposed between the open end part 11N and both the battery cover 14 and the safety valve mechanism 30, to thereby form the crimped structure 11R.

In such a manner, the open end part 11N of the battery can 11 was closed by the battery cover 14, and the battery device and other components were contained inside the battery can 11. As a result, the lithium-ion secondary battery of the cylindrical type was assembled.

### [Stabilization of Secondary Battery]

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of 4.2 V until a current reached 0.05 C. Upon discharging, the secondary battery was discharged with a constant current of 0.1 C until the voltage reached 3.0 V. Note that 0.1 C was a value of a current that caused a battery capacity (a theoretical capacity) of 4000 mAh to be completely discharged in 10 hours, and 0.05 C was a value of a current that caused the battery capacity of 4000 mAh to be completely discharged in 20 hours.

In this manner, the state of the secondary battery was electrochemically stabilized. The lithium-ion secondary battery of the cylindrical type was thus completed.

### [Evaluation of Battery Characteristic]

The secondary batteries were each subjected to an external short-circuit test according to UN 38.3 standard and evaluated in terms of performance by the following procedure, which revealed the results presented in Table 1. In the external short-circuit test, the secondary batteries were each overcharged by charging with a voltage of 4.3 V, and short-circuited by an electric wire having an electric resistance of 6 mΩ. Thereafter, the secondary batteries were each disassembled and checked for electrical continuity between the safety cover 31 and the stripper disk 33. When there was no electrical continuity, it was judged as “pass”, and when there was electrical continuity, it was judged as “fail”. The number of tests (n number) was set to 100, and the pass rate was obtained.

TABLE 1

| | | | | | Pass |
|---|---|---|---|---|---|
| | Configuration of stripper disk | | | | rate in |
| | Through | Opening | | | external |
| | hole in | area | Number | Number | short- |
| | vicinity | ratio | of | of | circuit test |
| | of hook | [%] | openings | hooks | [%] |
| Example 1 | Not | 39 | 6 | 6 | 95 |
| | provided | | | | |
| Comparative | Provided | 39 | 6 | 6 | 80 |
| example 1 | | | | | |

### Comparative Example 1

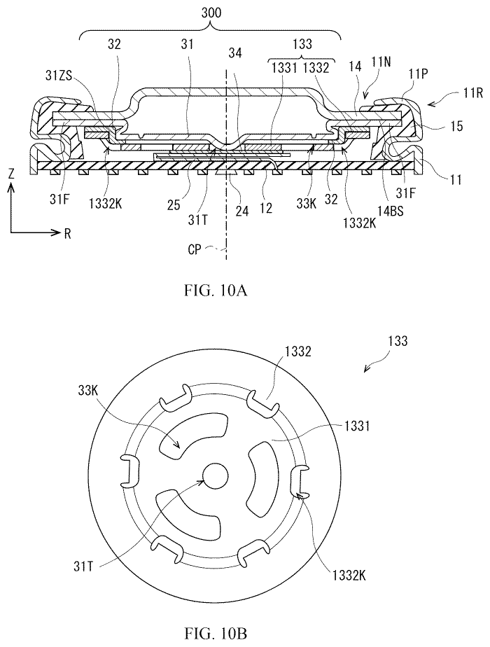

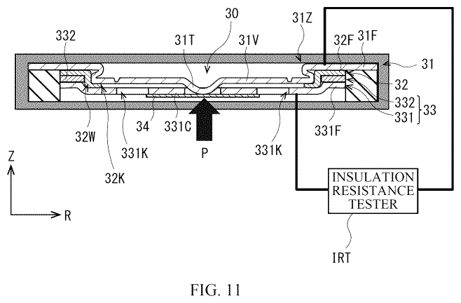

A secondary battery including a safety valve mechanism 300 according to a comparative example illustrated in FIG. 10A was fabricated. The secondary battery had substantially the same configuration as that of the secondary battery of Example 1 except that the secondary battery included the safety valve mechanism 300 instead of the safety valve mechanism 30. The safety valve mechanism 300 included a stripper disk 133. FIG. 10B schematically illustrates a plan configuration of the stripper disk 133. In the stripper disk 133, through holes 1332K each having a U-shape were provided in the vicinity of respective hooks 1332. The through holes 1332K each extended along an outer edge of the corresponding one of the hooks 1332. Accordingly, a portion of the disk holder 32 overlapped the through holes 1332K in the Z direction, and was exposed without being covered by a body 1331 of the stripper disk 133. The secondary battery of Comparative example 1 was also subjected to an external short-circuit test similar to that of Example 1. The results are also presented in Table 1.

As can be appreciated from Table 1, the pass rate in the external short-circuit test in Example 1 was higher than the pass rate in the external short-circuit test in Comparative example 1. When the samples of the secondary battery of Comparative example 1 were disassembled, some cases were observed in which the disk holder 32 flowed out from the through holes 1332K, causing the safety cover 31 and the stripper disk 133 to be in contact with each other. In contrast, according to the secondary battery of Example 1, the stripper disk 33 was provided to occupy the entire region that overlapped the disk holder 32 in the Z direction. According to Example 1, it was possible for the disk holder 32 to stay at the predetermined position without flowing out even in a case where heat was generated inside the battery can 11 and the disk holder 32 was softened. As a result, it was verified that unintentional contact was avoided between the flange part 31F and the stripper disk 33, enabling to achieve a high level of safety.

### Examples 2 to 5

The secondary batteries of Examples 2 to 5 were each fabricated in a manner similar to that of the secondary battery of Example 1. Note that, as can be appreciated from Table 2, the respective opening area ratios in Examples 2 to 5 were set to different values within a range of more than or equal to 40% and less than or equal to 81% by changing a size of each one of the openings 331K. The fabricated secondary batteries were each subjected to a safety valve activating pressure test and a projectile test according to UL 1642 and evaluated in terms of performance by the following procedure, which revealed the results presented in Table 2. A similar test was also performed on the secondary batteries of Example 1 and Comparative example 1.

### [Safety Valve Activating Pressure Test]

First, as illustrated in FIG. 11, the safety valve mechanism 30 was placed in a space insulated from surroundings and sealed except for an entrance and an exit for air. Thereafter, an insulation resistance tester IRT was coupled between the safety cover 31 and the stripper disk 33 of the safety valve mechanism 30. In this state, an air pressure P was applied in the Z direction from the side of the sub-disk 34. The air pressure P was gradually increased, and a pressure value (kg/cm²) when a resistance value measured by the insulation resistance tester IRT became infinite, i.e., a current cutoff pressure, was read. For each of Examples and the comparative example, 50 samples were subjected to the safety valve activating pressure test, and an average value and a standard deviation value of current cutoff pressures (safety valve activating pressures) were obtained.

### [Projectile Test]

The projectile test defined in UL 1642 uses a secondary battery in a completely discharged state. However, in each of Examples and the comparative example, the projectile test was performed on the secondary battery in a fully charged state, which was a stricter condition. In the projectile test defined in UL 1642, a center part of the secondary battery in a longitudinal direction is heated. However, in each of Examples and the comparative example, heating was performed on the battery can 11, at a position deviated from a central position in the Z direction, which served as the longitudinal direction, toward a bottom part by 15 mm. Except that the two test conditions described above were different, conditions of the projectile test in each of Examples and the comparative example were in accordance with the projectile test defined in UL 1642. Note that, here, the fully charged state was a state resulting from performing charging for 5 hours in an atmosphere at 23±2° C. with a constant voltage of 4.20 V and with a constant current of 4.0 A (where the battery capacity was 4000 mAh). Regarding a judgement criterion, a case where the entire secondary battery or a portion of the secondary battery did not fly through a test net was judged as “pass”, and a case where the entire secondary battery or a portion of the secondary battery flew through the test net was judged as “fail”. Note that the number of tests (n number) was set to 100, and the pass rate was obtained.

TABLE 2

| | | | | | Standard | |
|---|---|---|---|---|---|---|
| | | | | | deviation of | |
| | Configuration of stripper disk | | | | safety valve | |
| | Through hole | Opening | Number | Number | activating | Pass rate in |
| | in vicinity | area ratio | of | of | pressure | projectile |
| | of hook | [%] | openings | hooks | [kgf/cm²] | test [%] |
| Example 1 | Not | 39 | 6 | 6 | 0.27 | 70 |
| | provided | | | | | |
| Example 2 | Not | 40 | 6 | 6 | 0.35 | 85 |
| | provided | | | | | |
| Example 3 | Not | 47 | 6 | 6 | 0.33 | 95 |
| | provided | | | | | |
| Example 4 | Not | 80 | 6 | 6 | 0.41 | 99 |
| | provided | | | | | |
| Example 5 | Not | 81 | 6 | 6 | 0.42 | 100 |
| | provided | | | | | |
| Comparative | Provided | 39 | 6 | 6 | 0.41 | 85 |
| example 1 | | | | | | |

As can be appreciated from Table 2, in the secondary batteries of Examples 1 to 5, it was found that it was possible to reduce the standard deviation of the safety valve activating pressure as the opening area ratio was reduced. For example, it was found that when the opening area ratio was less than or equal to 80% (Examples 1 to 4), it was possible to reduce the variation to be equal to or less than that of the secondary battery of Comparative example 1. In the secondary batteries of Examples 1 to 5, it was found that as the opening area ratio was increased, the pass rate in the projectile test was increased. For example, it was found that when the opening area ratio was more than or equal to 40% (Examples 2 to 5), a projectile pass rate equal to or higher than that of the secondary battery of Comparative example 1 was obtained.

### Examples 6 to 8

The secondary batteries of Examples 6 to 8 were each fabricated in a manner similar to that of the secondary battery of Example 1. Note that, as can be appreciated from Table 3, the opening area ratio of each of the secondary batteries of Examples 6 to 8 was set to 47% by changing the size of each one of the openings 331K. Further, the number of the openings 331K in Example 6 was set to 5, the number of the openings 331K in Example 7 was set to 8, and the number of the openings 331K in Example 8 was set to 9. The secondary batteries fabricated as above were each subjected to the safety valve activating pressure test and the projectile test according to UL 1642, and evaluated in terms of performance by the above-described procedure, which revealed the results presented in Table 3.

TABLE 3

| | | | | | Standard | |
|---|---|---|---|---|---|---|
| | | | | | deviation of | |
| | Configuration of stripper disk | | | | safety valve | |
| | Through hole | Opening | Number | Number | activating | Pass rate in |
| | in vicinity | area ratio | of | of | pressure | projectile |
| | of hook | [%] | openings | hooks | [kgf/cm²] | test [%] |
| Example 1 | Not | 39 | 6 | 6 | 0.27 | 70 |
| | provided | | | | | |
| Example 6 | Not | 47 | 5 | 6 | 0.30 | 85 |
| | provided | | | | | |
| Example 3 | Not | 47 | 6 | 6 | 0.33 | 95 |
| | provided | | | | | |
| Example 7 | Not | 47 | 8 | 6 | 0.41 | 99 |
| | provided | | | | | |
| Example 8 | Not | 47 | 9 | 6 | 0.44 | 100 |
| | provided | | | | | |
| Comparative | Provided | 39 | 6 | 6 | 0.41 | 85 |
| example 1 | | | | | | |

As can be appreciated from Table 3, in the secondary batteries of Examples 3 and 6 to 8, it was found that it was possible to reduce the standard deviation of the safety valve activating pressure as the number of the openings 331K was reduced. It was also found that the pass rate in the projectile test was increased as the number of the openings 331K was increased. For example, it was found that when the number of the openings 331K was more than or equal to 6 (Examples 3, 7, and 8), a higher projectile pass rate was obtained.

### Examples 9 to 12

The secondary batteries of Examples 9 to 12 were each fabricated in a manner similar to that of the secondary battery of Example 1. Note that, as can be appreciated from Table 4, the number of the hooks 332A was different among Examples 9 to 12. Further, the opening area ratio was set to 47% in each of Examples 9 to 12. The secondary batteries fabricated as above were each subjected to a vibration test and evaluated in terms of performance by the following procedure, which revealed the results presented in Table 4.

### [Vibration Test]

The secondary battery in a completely discharged state was subjected to a sweep test in which vibration at a frequency of 7 Hz, vibration at a frequency of 200 Hz, and vibration at a frequency of 7 Hz were applied to the secondary battery in order for 15 minutes in total. Note that, here, the secondary battery in the completely discharged state was the secondary battery resulting from performing discharging until a voltage reached 2.5 V in an atmosphere at 23±2° C. with a constant current of 4.0 A. Further, vibration directions were set to three directions orthogonal to each other, including the Z direction. The sweep test was performed 12 times for each of the three directions. Regarding a judgement criterion, a case where a rate of an increase in alternating-current resistance after the sweep test was lower than 10% was judged as “pass”, and a case where the rate of the increase in the alternating-current resistance was higher than or equal to 10% was judged as “fail”. Regarding the alternating-current resistance, a battery tester was used to supply a constant alternating-current at a measurement frequency of 1 kHz and measure an internal resistance of the secondary battery from a voltage value of an alternating-current voltmeter. Note that the number of tests (n number) was set to 100, and the pass rate was obtained.

TABLE 4

| | Configuration of stripper disk | | | | Pass |
|---|---|---|---|---|---|
| | Through | Opening | | | rate in |
| | hole in | area | Number | Number | vibration |
| | vicinity | ratio | of | of | test |
| | of hook | [%] | openings | hooks | [%] |
| Example 1 | Not | 39 | 6 | 6 | 90 |
| | provided | | | | |
| Example 9 | Not | 47 | 6 | 5 | 80 |
| | provided | | | | |
| Example 10 | Not | 47 | 6 | 6 | 85 |
| | provided | | | | |
| Example 11 | Not | 47 | 6 | 8 | 95 |
| | provided | | | | |
| Example 12 | Not | 47 | 6 | 9 | 99 |
| | provided | | | | |
| Comparative | Provided | 39 | 6 | 6 | 85 |
| example 1 | | | | | |

As can be appreciated from Table 4, it was found from the comparison between Examples 9 to 12 that when the number of the hooks 332A was more than or equal to 6, a higher pass rate in the vibration test was obtained. In other words, it was verified that when the number of the hooks 332A was more than or equal to 6, a higher reliability was obtained.

Although some example embodiments and Examples of the present technology have been described in the foregoing by way of example with reference to the accompanying drawings, the present technology is by no means limited to the example embodiments and Examples described above.

For example, the description has been given of the case where the battery device has a device structure of a wound type. However, the device structure of the battery device is not particularly limited. In an embodiment, the device structure may thus be another device structure such as a stacked type in which the electrodes, i.e., the positive electrode and the negative electrode, are stacked on each other, or a zigzag folded type in which the electrodes, i.e., the positive electrode and the negative electrode, are folded in a zigzag manner.

Further, although the description has been given of the case where the electrode reactant is lithium, the electrode reactant is not particularly limited. In an embodiment, the electrode reactant may be another alkali metal such as sodium or potassium, or may be an alkaline earth metal such as beryllium, magnesium, or calcium, as described above. In an embodiment, the electrode reactant may be another light metal such as aluminum.

Note that the effects described herein are mere examples. The effects of an embodiment of the present technology are therefore not limited to the effects described herein. Accordingly, any other effect may be obtained in relation to an embodiment of the present technology.

Furthermore, the present technology encompasses any possible combination of some or all of the various example embodiments and the modification examples described herein and incorporated herein. It is possible to achieve at least the following configurations from the above-described example embodiments of the present technology.

(1)

A secondary battery including:
a battery device including a first electrode, a second electrode, and an electrolytic solution;
a container member containing the battery device; and
a safety valve mechanism attached to an end part of the container member in a height direction of the container member, in which
the safety valve mechanism includes
a valve member having an electrically conductive property, the valve member including a valve part and an annular protruding part, the valve part being electrically coupled to the first electrode and cleavable, the annular protruding part surrounding the valve part along a horizontal plane, the horizontal plane being orthogonal to the height direction,
an insulating holder surrounding the annular protruding part along the horizontal plane, and
an electrically conductive member including a hook member including a hook, the hook being opposed to the annular protruding part with the insulating holder interposed between the hook and the annular protruding part, the electrically conductive member occupying an entire region that overlaps the insulating holder in the height direction.

(2)

The secondary battery according to (1), in which the electrically conductive member includes a body that supports the hook member.

(3)

The secondary battery according to (2), in which the hook member is joined to the body by welding.

(4)

The secondary battery according to (1) or (2), in which the electrically conductive member is separate from a peripheral part on an outer side of the annular protruding part, and the insulating holder is interposed in a gap between the electrically conductive member and the peripheral part.

(5)

The secondary battery according to any one of (1) to (4), in which the electrically conductive member has one or more openings at respective one or more positions that overlap the valve part in the height direction.

(6)

The secondary battery according to (5), in which number of the one or more openings is more than or equal to six and less than or equal to eight.

(7)

The secondary battery according to (5) or (6), in which a ratio of a total opening area to a cleavage opening area is more than or equal to 40 percent and less than or equal to 80 percent, the total opening area being a sum of areas occupied by the one or more openings of the electrically conductive member along the horizontal plane, the cleavage opening area being an area occupied by the valve part along the horizontal plane.

(8)

The secondary battery according to any one of (1) to (7), in which the hook includes multiple hooks disposed around the annular protruding part along the horizontal plane.

(9)

The secondary battery according to (8), in which number of the hooks is more than or equal to six and less than or equal to nine.

(10)

The secondary battery according to any one of (1) to (9), in which
the safety valve mechanism includes an auxiliary member having an electrically conductive property, the auxiliary member being disposed between the first electrode and the valve part of the valve member, and
the valve part is electrically coupled to the first electrode via the auxiliary member.

(11)

The secondary battery according to any one of (1) to (10), in which
the container member includes a container and a cover, the container including an open end part through which the battery device is passable, the open end part being an end part of the container in the height direction, the cover closing the open end part, and
the safety valve mechanism is disposed on an inner side of the cover in the height direction.

(12)

The secondary battery according to (11), in which the valve member is positioned between the cover and the electrically conductive member.

(13)

The secondary battery according to any one of (1) to (12), in which the secondary battery includes a lithium-ion secondary battery.

According to a secondary battery of at least an embodiment of the present technology, an insulating holder is sandwiched between a peripheral part of a valve member and an electrically conductive member in a height direction. Accordingly, even when the insulating holder is softened due to generation of heat inside the battery, it is possible for the insulating holder to stay at a predetermined position without flowing out. As a result, unintentional contact is avoided between the peripheral part of the valve member and the electrically conductive member, allowing a safety valve mechanism to operate stably. This helps to achieve a high level of safety.

Note that effects of an embodiment of the present technology are not necessarily limited to the example effects described above and may include any of a series of effects described herein in relation to the example embodiments of the present technology and the modification examples thereof.

Although the present disclosure has been described hereinabove in terms of the example embodiment and modification examples, the present disclosure is not limited thereto. It should be appreciated that variations may be made in the described example embodiment and modification examples by those skilled in the art without departing from the scope of the present disclosure as defined by the following claims. The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated member, integer or step but not the exclusion of any other non-stated member, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A secondary battery comprising:
a battery device including a first electrode, a second electrode, and an electrolytic solution;
a container member containing the battery device; and
a safety valve mechanism attached to an end part of the container member in a height direction of the container member, wherein
the safety valve mechanism includes
a valve member having an electrically conductive property, the valve member including a valve part and an annular protruding part, the valve part being electrically coupled to the first electrode and cleavable, the annular protruding part surrounding the valve part along a horizontal plane, the horizontal plane being orthogonal to the height direction,
an insulating holder surrounding the annular protruding part along the horizontal plane, and
an electrically conductive member including a hook member including a hook, the hook being opposed to the annular protruding part with the insulating holder interposed between the hook and the annular protruding part, the electrically conductive member occupying an entire region that overlaps the insulating holder in the height direction.

2. The secondary battery according to claim 1, wherein the electrically conductive member includes a body that supports the hook member.

3. The secondary battery according to claim 2, wherein the hook member is joined to the body by welding.

4. The secondary battery according to claim 1, wherein the electrically conductive member is separate from a peripheral part on an outer side of the annular protruding part, and the insulating holder is interposed in a gap between the electrically conductive member and the peripheral part.

5. The secondary battery according to claim 1, wherein the electrically conductive member has one or more openings at respective one or more positions that overlap the valve part in the height direction.

6. The secondary battery according to claim 5, wherein a number of the one or more openings is more than or equal to six and less than or equal to eight.

7. The secondary battery according to claim 5, wherein a ratio of a total opening area to a cleavage opening area is more than or equal to 40 percent and less than or equal to 80 percent, the total opening area being a sum of areas occupied by the one or more openings of the electrically conductive member along the horizontal plane, the cleavage opening area being an area occupied by the valve part along the horizontal plane.

8. The secondary battery according to claim 1, wherein the hook comprises multiple hooks disposed around the annular protruding part along the horizontal plane.

9. The secondary battery according to claim 8, wherein a number of the hooks is more than or equal to six and less than or equal to nine.

10. The secondary battery according to claim 1, wherein
the safety valve mechanism includes an auxiliary member having an electrically conductive property, the auxiliary member being disposed between the first electrode and the valve part of the valve member, and
the valve part is electrically coupled to the first electrode via the auxiliary member.

11. The secondary battery according to claim 1, wherein
the container member includes a container and a cover, the container including an open end part through which the battery device is passable, the open end part being an end part of the container in the height direction, the cover closing the open end part, and
the safety valve mechanism is disposed on an inner side of the cover in the height direction.

12. The secondary battery according to claim 11, wherein the valve member is positioned between the cover and the electrically conductive member.

13. The secondary battery according to claim 1, wherein the secondary battery comprises a lithium-ion secondary battery.
